(19) United States
(12) Patent Application Publication
(10) Pub. No.: US 2025/0274738 A1
(43) Pub. Date: Aug. 28, 2025

(54) METHODS AND SYSTEMS FOR SUBSCRIBER DATA INTEGRITY ASSUANCE AND AUTO-CORRECTIONS

(71) Applicant: T-Mobile USA, Inc., Bellevue, WA (US)

(72) Inventors: Anuj Sharma, Broadlands, VA (US); Deepesh Belwal, Ashburn, VA (US)

(21) Appl. No.: 18/584,846

(22) Filed: Feb. 22, 2024

(51) Int. Cl. H04W 8/18; H04W 8/20

(52) U.S. Cl. CPC H04W 8/183; H04W 8/186; H04W 8/20

(57) ABSTRACT

Methods and systems for subscriber data integrity assurance and auto-corrections are described herein. According to an implementation, the computer device may receive, from a client device, a request to perform a provisioning operation with respect to a first subscription in a subscription database. Prior to the provisioning operation, the computer device may obtain, from an index repository, a plurality of unique identities (UIDs) and associated indexes for a plurality of subscriptions of a telecommunication service provider. The computer device may further audit, based on the plurality of UIDs and associated indexes, a subscription database to generate an auditing result. If the auditing result indicates an error in the subscription database, the computer device may instruct the client device to refresh the impacted indexes and/or UIDs in the subscription database. If the auditing result indicates no error or the error is corrected, the computer device may perform the provisioning operation.

### BACKGROUND

A telecommunication service provider may have multiple databases to store subscription data associated with all its subscribers. Subscription data, for example, may be structured and stored with the keys, indexes, and/or identities being hosted by a database routing layer (also referred to as an access layer, or front-end servers), while the real subscription data being hosted and distributed across multiple redundant storage clusters (also referred to as storage layers, or back end servers). Each subscription may have multiple keys, indexes, and/or identities that can be used for accessing the subscription profile and/or for provisioning operations.

In implementations, the linkage between the keys/indexes/identities and the corresponding subscription profile is constantly updated during CRUD (e.g., create, read, update, delete) operations by the mainline provisioning clients, e.g., billing/customer relationship management (CRM) clients, and network access applications. In some examples, a unique identity (UID) may be created to map the keys/indexes in the front end (FE) servers and the subscription profiles in the back end (BE) servers. However, a translation from the keys/indexes/identities in the front-end servers to the real subscription data in the back-end servers may be corrupted. For example, a key/index/identity may remain hanging in the FE servers while the corresponding subscriber profile is deleted in the BE servers. In another example, a key/index/identity gets deleted from the FE servers while the corresponding subscriber profile remains in the BE servers. In yet another example, some indexes of a subscription may not point to a same UID associated with the subscription.

Correct linkage between the keys/indexes/identities stored in the FE servers and corresponding subscription profile stored in the BE servers must be ensured at any given time such that the database remains healthy to serve the client application traffic error free.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example data storage deployment, in which techniques for subscriber data integrity assurance and auto-corrections are implemented, according to an implementation of the present disclosure.

FIG. 2 illustrates another example data storage deployment, in which techniques for subscriber data integrity assurance and auto-corrections are implemented, according to an implementation of the present disclosure.

FIG. 3 illustrates an example diagram for implementing the techniques for subscriber data integrity assurance and auto-corrections, according to an implementation of the present disclosure.

FIG. 4 illustrates another example diagram for implementing the techniques for subscriber data integrity assurance and auto-corrections, according to an implementation of the present disclosure.

FIG. 5 illustrates an example process for implementing the techniques for subscriber data integrity assurance and auto-corrections, according to an implementation of the present disclosure.

FIG. 6 illustrates another example process for implementing the techniques for subscriber data integrity assurance and auto-corrections, according to an implementation of the present disclosure.

FIG. 7 illustrates an example computer device that implements techniques for subscriber data integrity assurance and auto-corrections, according to the present disclosure.

### DETAILED DESCRIPTION

Techniques for subscriber data integrity assurance and auto-corrections are disclosed herein.

According to an aspect of the present disclosure, a computer device comprises a processor and a non-transitory computer-readable memory storing computer-executable instructions that, when executed by the processor, cause the processor to perform operations to implement techniques for subscriber data integrity assurance and auto-corrections. The computer device may receive, from a client device, a request to perform a provisioning operation with respect to a first subscription in a subscription database. Prior to the provisioning operation, the computer device may obtain, from an index repository, a plurality of unique identities (UIDs) and associated indexes for a plurality of subscriptions of a telecommunication service provider. The computer device may further audit, based on the plurality of UIDs and associated indexes, a subscription database to generate an auditing result. If the auditing result indicates no error in the subscription database, the computer device may perform the provisioning operation with respect to the first subscription in the subscription database. Once the provisioning operation is performed successfully, the computer device may return a response to the client device.

In implementations, the auditing result may indicate one or more errors in the subscription database. The computer device may send the audit result to the client device to correct the one or more errors. The audit result may include one or more pre-defined error codes to indicate the subscription data integrity issues and a list of identifiers that are impacted by the one or more errors (e.g., indexes, keys, and/or UIDs). Upon receiving the audit result, the client device may generate an automatic clean-up and refresh the impacted identifiers (e.g., indexes, keys, and/or UIDs) in the subscription database using corresponding identifiers stores in a billing/customer relationship management (CRM) database.

In some examples, auditing the subscription database may include querying indexes stored in a first storage of the subscription database (e.g., access layer or front-end servers). For associated indexes, the computer device may determine whether all associated indexes point to a same unique identity (UID). When the associated indexes do not point to the same UID, the computer device may determine that there is an error in the subscription database.

Alternatively or additionally, auditing the subscription database may include querying UIDs stored in a second storage of the subscription database (e.g., storage layer or back-end servers). For each UID, the computer device may identify one or more indexes mapped to the UID and further determine whether mappings of the one or more indexes to the UID are correct. In addition, the computer device may determine the index attributes stored in the profiles are mapped to the correct UID. When at least one mapping of the one or more indexes to the UID is incorrect and/or at least one index attribute is mapped to a wrong UID, the computer device may determine that there is an error in the subscription database.

In implementations, the auditing on the access layer and the storage layer of the subscription database may be performed simultaneously for different indexes, keys, IDs, and/or UIDs. The auditing may be performed in parallel for those different indexes, keys, IDs, and/or UIDs.

In implementations, the first subscription may be a new subscription and the computer device may perform provisioning operation to activate the new subscription. The request may generally include an identity of the first subscription. The computer device may query the index repository for the identity of the first subscription. If the identity of the first subscription is not found in the index repository, the UID and associated indexes for the new subscription may be written to the index repository after the provisioning operation completes. For example, during the provisioning operation to activate the new subscription, the computer device may write all associated indexes for the new subscription in the access layer of the subscription database and write profile data in the storage layer of the subscription database. The profile data for the new subscription may be associated with a unique identity (UID). The computer device may update the index repository to include a new mapping between the UID and associated indexes for the new subscription.

In some examples, the identity of the first subscription may be found in the index repository, which may indicate a data integrity issue. The computer device may instruct the client device to refresh and release the UID and associated indexes in the subscription database for the use of the new subscription. The newly created mapping between the UID and associated indexes for the new subscription may be written back to the index repository after the provisioning operation is completed.

In other implementations, the first subscription may be an existing subscription and the computer device may perform provisioning operation to review, modify, deactivate, or suspend the first subscription. The request may generally include an identity of the first subscription. The computer device may retrieve mappings between associated indexes and UID for all existing subscriptions from the index repository and audit the subscription database to ensure the data integrity prior to perform the provisioning operation for the existing subscription. If the provisioning operation for the existing subscriptions is performed successfully and there is an update on the indexes/keys/IDs/UID for the existing subscription, the computer device may update the index repository to include an updated mapping between the UID and the associated indexes for the first subscription.

The index repository may be a database separate from a subscription database and configured to store the mappings between UIDs and associated indexes for all the subscriptions of the telecommunication service provider. The index repository may be accessible to all computer devices capable of performing provisioning operations (e.g., provisioning orchestrator, or provisioning orchestrator instances) and may be deployed on any local storage sites/servers or remote storage sites/servers.

As discussed herein, existing audit techniques may mandate sweeping the entire database and all storage segments, which is time-consuming and normally runs as a low priority operation. The output of the auditing process may be in a format that requires manual intervention for re-conciliations. According to the present disclosure, the provisioning orchestrator may proactively audit the mappings between UIDs and associated indexes for all subscription data in the database each time a provisioning operation and/or a subscriber profile access operation is to be performed. Rather than sweeping the entire database, the present disclosure may query the indexes/keys in the access layer and unique identifiers (UIDs) of subscribers in the storage layer in parallel to identify any inconsistencies between the indexes and the UIDs. The provisioning orchestrator may then correct these inconsistencies between the indexes and the UIDs before provisioning and/or accessing the subscriber profiles, thus, minimizing the provisioning operation failures and issues with subscriber profile access operation.

The techniques discussed herein may be implemented in a computer network using one or more of protocols including but are not limited to Ethernet, third generation (3G), fourth generation (4G), Long-Term Evolution (LTE), fifth generation (5G), sixth generation (6G), the further radio access technologies, or any combination thereof. In some examples, the network implementations may support standalone architectures, non-standalone architectures, dual connectivity, carrier aggregation, etc. Example implementations are provided below with reference to the following figures.

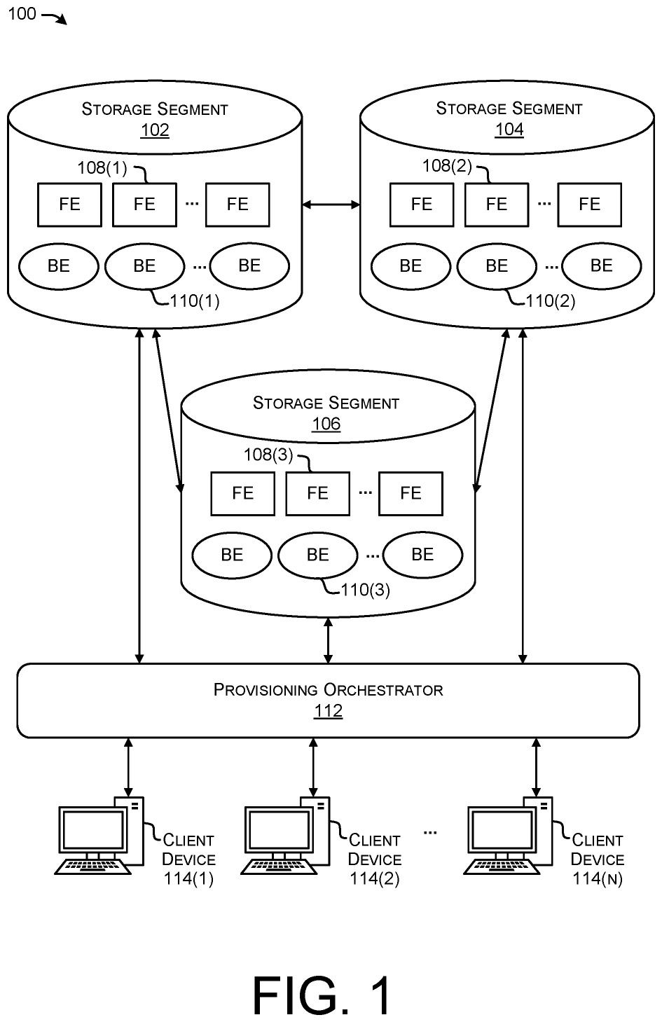

FIG. 1 illustrates an example data storage deployment, in which techniques for subscriber data integrity assurance and auto-corrections are implemented, according to an implementation of the present disclosure.

According to the data storage deployment 100, subscription data of a telecommunication service provider may be replicated and stored in a plurality of storage segments such as storage segment 102, storage segment 104, and storage segment 106. In some examples, a unified data repository (UDR) deployment may be utilized to store the subscription data in storage segment 102, storage segment 104, and storage segment 106. In that case, each of storage segment 102, storage segment 104, and storage segment 106 may be a UDR segment. In implementations, storage segment 102, storage segment 104, and storage segment 106 may be deployed in different geographic locations across the network. Although not shown, a central database of the telecommunication service provider may be managed by a provisioning orchestrator 112, which functions as an entry point to the network.

In implementations, a client device, e.g., client device 114(1), client device 114(2), . . . , or client device 114(n) (hereinafter referred to as client device 114), may initiate a life cycle operation (LCO) request for a subscription and send the LCO request to the provisioning orchestrator 112. In general, the LCO request may include an identity of the subscription and the subscription data to be provisioned to the central database and all the storage segments (e.g., storage segment 102, storage segment 104, and storage segment 106). The life cycle operation may include activating a subscription and creating a subscriber profile, deactivating s subscription and deleting the corresponding subscriber profile, accessing a subscriber profile, modifying a subscriber profile, accessing the subscriber data for a hotline call, suspending an existing subscription, changing existing subscription plan, etc. The identity of the subscription may be represented by multiple indexes or keys, using which, the provisioning orchestrator 112 may perform the life cycle operation in the central database and all the storage segments. In some examples, the indexes or keys may represent one or more identities of a subscriber, including but not limited to, Subscription Permanent Identifier (SUPI), Subscription Concealed Identifier (SUCI), International Mobile Subscriber Identifier (IMSI), Mobile Station International Subscriber Directory Number (MSISDN), IP Multimedia Private Identity (IMPI), IP Multimedia Public Identity (IMPU), Business Account Number (BAN), customerlD, Integrated Circuit Card ID (ICCID), International Mobile Equipment Identity (IMEI), etc.

In some examples, a provisioning workflow of a life cycle operation may include provisioning the indexes or keys associated with the subscription to front end (FE) servers of the central database and each of storage segment 102, storage segment 104, and storage segment 106, and provisioning the subscription data to back end (BE) servers of the central database and each of storage segment 102, storage segment 104, and storage segment 106. As discussed herein, indexes/keys stored in FE 108(1) of storage segment 102, FE 108(2) of storage segment 104, and FE 108(2) of storage segment 106 may be replicas to each other. Similarly, subscription data stored in BE 110(1) of storage segment 102, BE 110(2) of storage segment 104, and BE 110(3) of storage segment 106 may be replicas to each other.

In implementations, the life cycle operation request may be initiated by the client device 114 in a retail store. For example, when a customer walks in the retail store to activate a service, or to makes changes to the subscribed plan, a request to create a subscriber profile or update an existing subscriber profile may be generated by the client device 114 and sent to the provisioning orchestrator 112. In some examples, the life cycle operation request may be initiated when a customer activates the service using the client device 114 to access an online website or a mobile app of the telecommunication service provider. For instance, activating the service using eSIM to port an existing number may automatically generate a request to create a subscriber profile in the database of the new service provider and another request to delete the subscriber profile from the database of the old service provider. In another example, the customer may make a phone call to activate a service or to make changes to the existing service. The customer service representative may operate the client device 114 at the customer service department to send a request to provision the subscription data.

The client device 114 may be a mobile device, such as a cellular phone or a smart phone, a personal digital assistant (PDA), a media player, a tablet computer, a gaming device, a personal computer (PC) such as a laptop, desktop, or workstation, or any other type of computing or communication device. In some examples, the client device 114 may include the computing devices implemented on the vehicle such as an autonomous vehicle or a self-driving vehicle. In some other examples, the client device 114 may be a wearable device such as a smart watch, smart glasses, etc.

In implementations, the life cycle operation may fail to provision the subscription data if the database or the storage segment is corrupted. The failure of the provisioning may be due to misaligned indexes/keys in the front-end servers and the subscription data in the back-end servers. For instance, an index in the FE server may point to a deleted or wrong subscriber profile in the BE server, or a subscriber profile in the BE server may lack of an index in the FE server, etc. The provisioning orchestrator 112 may return a failure response to the client device 114. A manual intervention to correct an inconsistent linkage between the indexes and the subscriber profile may be needed before retrying the provisioning operation.

To address the issue, the provisioning orchestrator 112 may perform auditing and data correction on the database and/or the storage segment. Existing techniques may mandate sweeping the entire database and all storage segments, which is time-consuming and requires additional database resources. Output of the auditing process is often in a form of a log listing the outlier indexes and/or subscribers that requires manual intervention for re-conciliations. Further, the auditing operation normally runs as a low priority operation, and can be further delayed when the database and/or the storage segment has higher than normal load. This reduces customer satisfaction and increases customer handling challenges and/or costs.

The present disclosure implements an approach on the provisioning orchestrator 112 to proactively audit the database and/or the storage segment each time a provisioning operation and/or a subscriber profile access operation is to be operated. Instead of sweeping the entire database and all storage segments, the present disclosure may query the indexes/keys in the FE servers and unique identifiers (UIDs) of subscribers in the BE servers in parallel to identify any inconsistencies between the indexes and the subscriber profiles. The provisioning orchestrator 112 may then correct these inconsistencies between the indexes and the subscriber profiles before provisioning and/or accessing the subscriber profiles, thus, minimizing the provisioning operation failures and issues with subscriber profile access operation.

It should be appreciated that the data storage deployment 100 is for the purpose of illustration. The present disclosure is not intended to be limiting. The techniques discussed herein may be implemented in any database such as lightweight directory access protocol (LDAP) server, a relational database management system (RDBMS), document-based databases, etc.

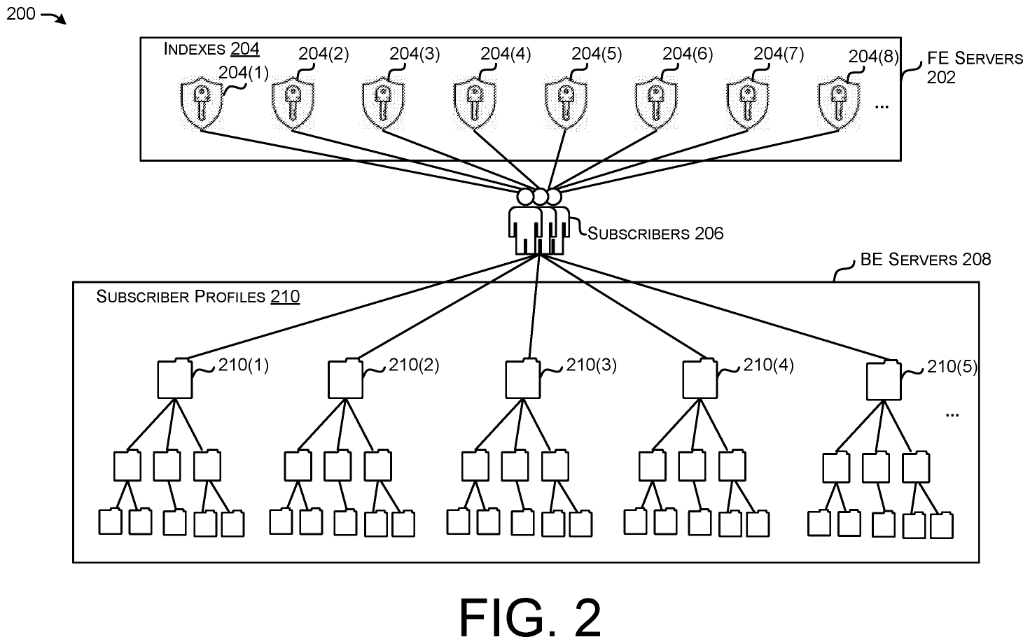

FIG. 2 illustrates another example data storage deployment, in which techniques for subscriber data integrity assurance and auto-corrections are implemented, according to an implementation of the present disclosure.

The data storage deployment 200 illustrates a linkage between the indexes associated with a subscriber stored in a front-end server and the subscriber profiles stored in a back-end server a storage segment. As illustrated, front end (FE) servers 202 may store a plurality of indexes 204 (e.g., index 204(1), index 204(2), index 204(3), index 204(4), index 204(5), index 204(6), index 204(7), index 204(8), . . . ) associated with subscribers 206 of a telecommunication service provider, and back end (BE) servers 208 may store the subscriber profiles 210 of those subscribers (e.g., profile 210(1), profile 210(2), profile 210(3), profile 210(4), profile 210(5), . . . ). In some examples, one or more of index 204(1), index 204(2), index 204(3), index 204(4), index 204(5), index 204(6), index 204(7), index 204(8), . . . ) (hereinafter referred to as indexes 204) associated with a particular subscriber may be linked to a corresponding profile of the particular subscriber stored in the BE servers 208.

In some examples, the indexes 204 of the particular subscriber 206 may directly and/or indirectly point to a unique identifier (UID) used to identify the subscriber profile 210 in the BE server 208. In some examples, the storage nodes that store the indexes 204 associated with the subscriber 206 may be linked together using hash values. For instance, a storage node that stores the MSISDN information may include a has value pointing to a storage node that stores the IMEI information. In some examples, one or more storage nodes storing the indexes 204 may include hash values that point to a storage node storing the UID associated with the subscriber 206. In yet some other examples, the UID and all indexes associated with the subscriber 206 may be linked together to form a block chain in the FE servers 202.

The subscriber profile 210 associated with the subscriber may be stored in various storage nodes in the BE servers 208. For example, data associated with the second generation (2G) and the third generation (3G) service subscribers may be stored in a Home Location Registry (HLR). In another example, data associated with the fourth generation (4G) and the fifth generation (5G) service subscribers may be stored in a Home Subscriber Server (HSS), a Unified Data Registry (UDR), or a Unified Data Management (UDM). In yet another example, data plan information and/or device information associated with the subscriber may be stored in separate storage nodes in the BE servers 208.

In implementations, a client device (e.g., client device 114 of FIG. 1) may receive a request to activate a subscription. A provisioning orchestrator (e.g., provisioning orchestrator 112 of FIG. 1) may perform a subscriber life cycle operation to create a new subscriber profile in the BE servers 208 and store associated indexes in the FE servers 202. For instance, the new subscriber profile stored in the BE servers 208 may include the name and address of the subscriber, the payment information such as credit card and/or social security number (SSN) of the subscriber, subscribed plan details, subscription period, user equipment (UE) used to activate the subscription, etc. The indexes stored in the FE servers 202 may correspond to the MSISDN associated with the subscriber, the IMSI associated with the subscriber, the IMEI associated with the UE used to activate the subscription, the ICCID associated with the UE, etc. The provisioning orchestrator may further generate a UID for the new subscriber and associate the UID with the new subscriber profile in the BE servers 208. Additionally, the provisioning orchestrator may generate a mapping between the UID and each associated index for the new subscriber and store the mapping in the FE servers 202.

In another implementation, the client device may receive a request to update personal information of an existing subscriber. The request may include an identity of the existing subscriber such as name or phone number. The provisioning orchestrator may perform a subscriber life cycle operation to update the personal information of the existing subscriber. In implementations, the provisioning orchestrator may first retrieve the indexes associated with the existing subscriber by querying the FE servers 202 using the identity of the subscriber. The provisioning orchestrator may further locate the profile associated with the personal information of the existing subscriber in the BE servers 208 using the UID and update the personal information in response to the request.

Similarly, for other life cycle operations associated with the existing subscribers such as deactivating a service, suspending a service, upgrading or downgrading the plan, switching devices, updating payment information, etc., the provisioning orchestrator may retrieve the indexes stored in the front end servers 202 and then perform the transactions on the subscriber profiles stored in the back end servers 208. The provisioning orchestrator may additionally perform the transactions on the indexes stored in the front-end servers such as updating a phone number, updating data related to the user equipment, etc.

As discussed herein, correct data linkage between the indexes stored in the front-end servers and the subscriber profiles stored in the back-end servers at any time is critical for the telecommunication service provider to provide error free service to the clients. The provisioning orchestrator and/or other network entities that perform similar functions may perform an auditing operation on the data storage prior to performing the life cycle operation. Unlike the existing auditing process, in which, sweeping the entire data storages in a certain period and fixing any errors may take 20 to 30 minutes, the auditing process according to the present disclosure may take 30 to 40 milliseconds to only audit the linkage and/or relationships between the indexes and UIDs and correct any inconsistencies between the indexes and UIDs or subscriber profiles.

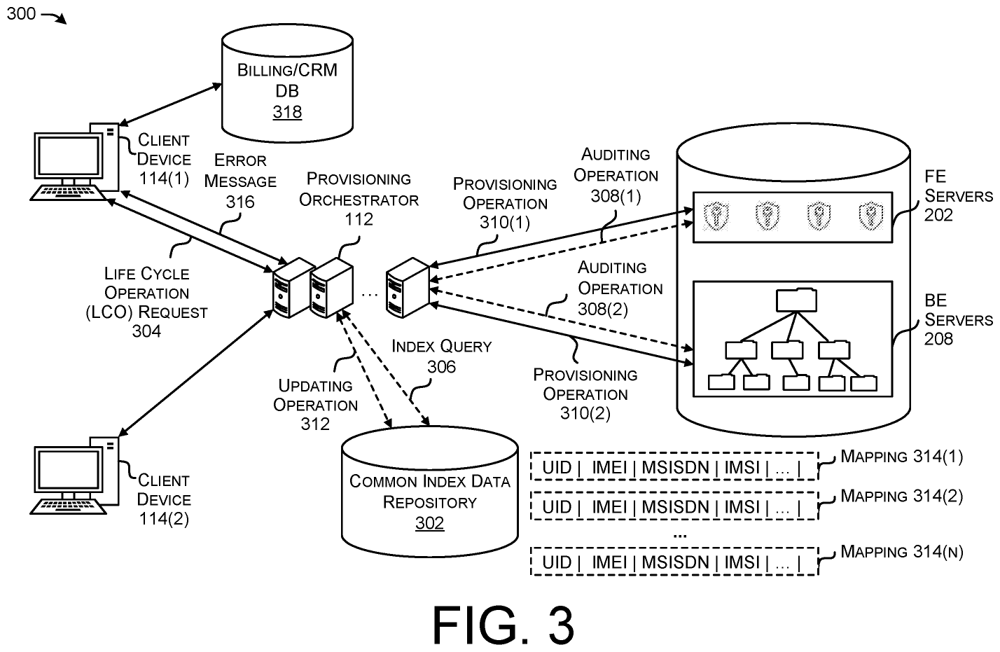

FIG. 3 illustrates an example diagram for implementing the techniques for subscriber data integrity assurance and auto-corrections, according to an implementation of the present disclosure.

According to the example diagram 300, a provisioning orchestrator (e.g., the provisioning orchestrator 112 of FIG. 1) may send an index query 306 to a common index data repository 302 upon receiving a life cycle operation (LCO) request 304 from a client device 114(1). The common index data repository 302 may be configured to store the mappings between UIDs and all indexes associated with all subscribers. In implementations, the common index data repository 302 may be deployed in any local and/or remote sites (e.g., storage nodes, storage servers, etc.) accessible to all provisioning orchestrator instances in the telecommunication network. As discussed herein, the LCO request 304 sent from the client device 114(1) may include an identity of a subscriber such as, name, mobile phone number, IMEI number, etc. The provisioning orchestrator 112 may query the common index data repository 302 using the identity of the subscriber and retrieve a mapping 314(1) that includes a UID and all indexes associated with the identity of the subscriber. For example, the mapping 314(1) may include a UID and indexes corresponding to IMEI, MSISDN, IMSI, etc. In implementations, to ensure the data integrity in the storage nodes/servers prior to provisioning, the provisioning orchestrator 112 may obtain additional mappings 314(2), . . . , 314(n) from the common index data repository 302. These additional mappings may include all other mappings saved in the common index data repository 302 that may be related to other subscribers of the telecommunication service provider.

In some examples, the provisioning orchestrator 112 may audit the data storage segments (e.g., storage segment 102, storage segment 104, and/or storage segment 106, as shown in FIG. 1) based on the mappings 314(1), 314(2), . . . , 314(n) (hereinafter referred to as mapping 314). The provisioning orchestrator 112 may audit both the front-end servers (e.g., FE servers 202 shown in FIG. 2) and the back-end servers (e.g., BE servers 208 shown in FIG. 2). For instance, in an auditing operation 308(1) performed on the FE servers 202, the provisioning orchestrator 112 may query the indexes indicated each mapping 314, and determine whether all the indexes indicated in the mapping 314 are present in the FE servers 202 and whether all the indexes in the mapping 314 are pointing to a same UID. In some examples, in an auditing operation 308(2) performed on the BE servers 208, the provisioning orchestrator 112 may query the UID indicated in each mapping 314, and determine whether proper index attributes are mapped to the UID correctly. For example, the provisioning orchestrator 112 may determine whether an index representing an IMEI number of the subscriber and the IMEI number are mapped to the UID representing the profile of the subscriber correctly.

In implementations, the auditing operation 308(1) on the FE servers 202 and the auditing operation 308(2) on the BE servers 208 may be performed in parallel for different indexes and UIDs. When the auditing operation succeeds, e.g., both the auditing operation 308(1) on the FE servers 202 and the auditing operation 308(2) on the BE servers 208 indicate no error, the provisioning orchestrator 112 may perform provisioning operation with respect to the requested subscriber. The provisioning orchestrator 112 may perform a provisioning operation 310(1) on the front-end servers (e.g., FE servers 202) and a provisioning operation 310(2) on the back-end servers (e.g., BE servers 208) in parallel. As discussed herein, the provisioning operation 310(1) may be performed on the indexes with respect to the requested subscriber, and the provisioning operation 310(2) may be performed on the profiles with respect to the requested subscriber.

In some examples, the LCO request 304 may be related to a new subscriber. The provisioning orchestrator 112 may perform the provisioning operation 310(1) to create all indexes for the new subscriber on the FE servers 202, and perform the provisioning operation 310(2) to create the profile for the new subscriber on the BE servers 208. In some other examples, the LCO request 304 may be related to an existing subscriber. The provisioning orchestrator 112 may perform the provisioning operation 310(1) to retrieve the indexes for the existing subscriber on the FE servers 202, and perform the provisioning operation 310(2) to modify the profile for the existing subscriber on the BE servers 208. Once the provisioning operation 310(1) and the provisioning operation 310(2) are performed successfully, the provisioning orchestrator 112 may send a response back to the client device 114(1). In some examples, the provisioning orchestrator 112 may further generate a new and/or updated mapping between the UID and the indexes of the subscriber and perform an updating operation 312 on the common index data repository 302 to include the new and/or updated mapping.

In some examples, when the auditing operation fails, e.g., the auditing operation 308(1) on the FE servers 202 and/or the auditing operation 308(2) on the BE servers 208 fails, the provisioning orchestrator 112 may send an error message 316 to the client device 114(1). The error message 316 may include one or more pre-defined error codes that indicate the subscription data integrity issues. Alternatively and/or additionally, the error message 316 may include a list of UIDs, keys, and/or indexes that are impacted by the identified subscription data integrity issues. For example, a pre-defined error code may indicate an index associated with a profile is not found in the front-end servers. In another example, a pre-defined error code may indicate an index in the front-end servers is pointing to a non-existing profile in the back-end servers. In yet another examples, a pre-defined error code may indicate an index in the front-end servers is pointing to a wrong profile in the back-end servers. In yet another examples, a pre-defined error code may indicate a UID associated with a subscription is associated with one or more wrong indexes/keys in the front-end servers. Upon receiving the error message 316, the client device 114(1) may issue an automated clean-up command to refresh the impacted identities (e.g., indexes, keys, IDs, UIDs, etc.) using the corresponding identities stored in a billing/CRM database 318. As such, all impacted identities may be synchronized with the billing/CRM database 318.

As discussed herein, according to the present disclosure, the auditing operations performed on the data storage may check only the mapping/relationship between the indexes and UIDs for the subscribers. The errors in the data storage may be detected when inconsistencies between the indexes in the front-end servers and the profiles in the back-end servers present. In addition, correcting these errors in the data storage can be more efficient as only the impacted identities need to be corrected.

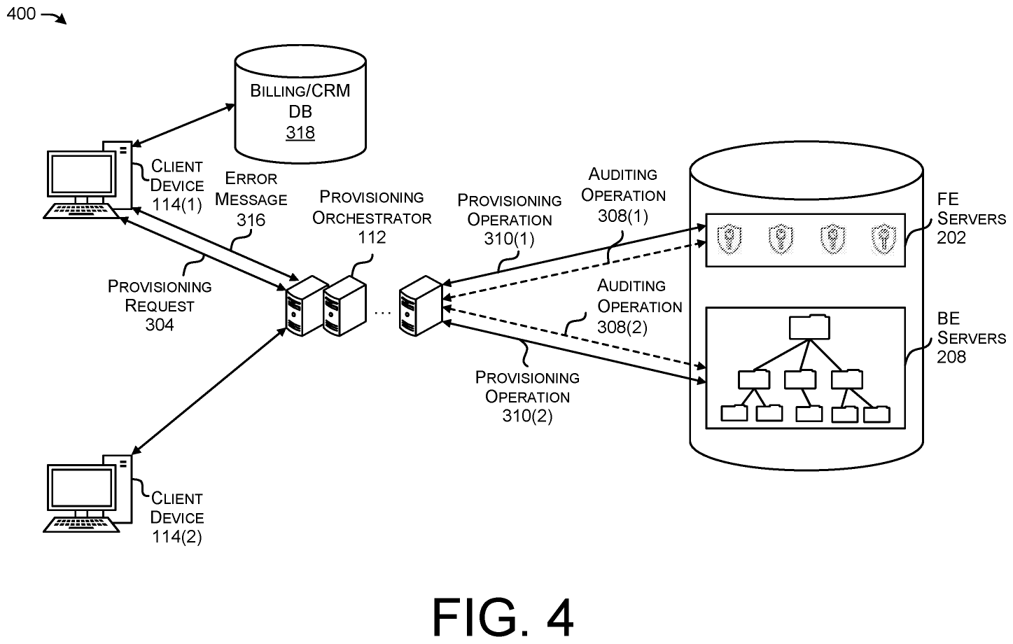

FIG. 4 illustrates another example diagram for implementing the techniques for subscriber data integrity assurance and auto-corrections, according to an implementation of the present disclosure.

According to the example diagram 400, the provisioning orchestrator 112 may audit the data storage without using the information stored in the common index data repository 302. In implementations, upon receiving the LCO request 304 from the client device 114(1), the provisioning orchestrator 112 may initiate an auditing on the data storage prior to the provisioning operation. The provisioning orchestrator 112 may query existing indexes/keys in the front-end servers (e.g., FE servers 202), and determine whether all associated indexes/keys are present in the front-end servers. In some examples, a first response to an index query from the front-end servers (e.g., FE servers 202) may include the associated UID. The provisioning orchestrator 112 may then determine whether all associated indexes/keys are pointing to the same UID. In some examples, the provisioning orchestrator 112 may further query the UIDs in the back end servers and determine whether proper index contributes and associated indexes are mapped to the UIDs correctly. The auditing operation 308(1) on the front-end servers and the auditing operation 308(2) on the back-end servers may be performed in parallel for all different indexes and/or index attributes.

When both the auditing operation 308(1) on the FE servers 202 and the auditing operation 308(2) on the BE servers 208 indicate no error, the provisioning orchestrator 112 may perform provisioning operation according to the LCO request 304 from the client device 114(1). The provisioning orchestrator 112 may perform a provisioning operation 310(1) on the front-end servers (e.g., FE servers 202) and a provisioning operation 310(2) on the back-end servers (e.g., BE servers 208) in parallel. When the auditing operation fails, e.g., the auditing operation 308(1) on the FE servers 202 and/or the auditing operation 308(2) on the BE servers fails, the provisioning orchestrator 112 may send an error message 316 to the client device 114(1). Similar to the example diagram 300, the error message 316 may include one or more pre-defined error codes that indicate the subscription data integrity issues and a list of UIDs, keys, and/or indexes that are impacted by the subscription data integrity issues. Upon receiving the error message 316, the client device 114(1) may refresh the impacted identities (e.g., indexes, keys, IDs, UIDs, etc.) using the identities (e.g., indexes, keys, IDs, UIDs, etc.) stored in a billing/CRM database 318 to ensure the data integrity prior to the provisioning operations.

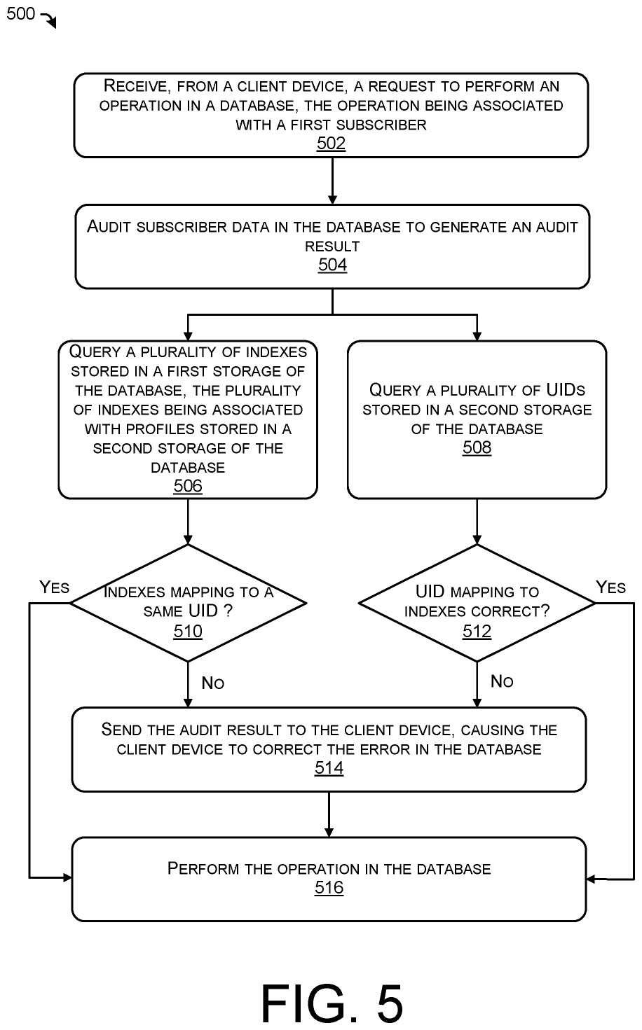

FIG. 5 illustrates an example process for implementing the techniques for subscriber data integrity assurance and auto-corrections, according to an implementation of the present disclosure. The example process 500 may be implemented on a provisioning orchestrator (e.g., the provisioning orchestrator 112 as illustrated in FIG. 1, FIG. 3, and FIG. 4) and/or a provisioning orchestrator instance in a telecommunication network. The example process 500 may correspond to the example diagram 400, where an auditing operation is performed directly from provisioning orchestrator, as illustrated in FIG. 4.

At operation 502, the process may include receiving, from a client device, a request to perform an operation in a database, the operation being associated with a first subscriber. As discussed herein, the operation may include a provisioning operation with respect to a new subscription and/or an existing subscription related to the first subscriber. The request may include activating a subscription for the first subscriber, where the first subscriber is a new subscriber to a telecommunication service provider. In some examples, the request includes modifying the subscription of the first subscriber such as adding a line to the plan for a family member, suspending the subscription for a period of time, or deactivating the subscription, etc. In some examples, the operation may include an access operation with respect to the existing subscription such as verifying information associated with the first subscriber when receiving a hotline call.

The database may be configured to store subscription data associated with all subscribers of a telecommunication service provider. The database may be deployed as a Unified Data Repository (UDR), a Unified Data Management (UDM), a Home Location Registry (HLR), a Home Subscriber Server (HSS), etc. The subscription data may be stored in in various structures. For example, indexes/keys/identities associated with the subscription may be stored in an access layer of the database (also referred to as routing layer or front-end servers) while the real subscription profiles may be stored in a storage layer (also referred to as storage nodes, storage clusters, or back-end servers).

At operation 504, the process may include auditing subscriber data in the database to generate an audit result. As discussed herein, upon receiving the request to perform an operation on the database, the provisioning orchestrator may proactively initiate an auditing process on the database to ensure the integrity of the data stored in the database before performing the operation. For a UDR deployment database, the auditing process may be performed on the front-end servers and the back-end servers, as described in operation 506 and operation 508, respectively. The auditing for all different indexes and/or UIDs may be performed in parallel.

At operation 506, to audit the subscriber data in the database, the process may further include querying a plurality of indexes stored in a first storage of the database, a plurality of indexes being associated with profiles stored in a second storage of the database. In general, if the mapping between the indexes and the UID is correct, all indexes associated with a particular subscriber may point to a same UID associated with the profiles of the subscriber. The operation 506 may also be referred to as an access layer auditing or a front-end server auditing.

At operation 510, the process may include determining whether associated indexes map to a same UID. As discussed herein, indexes corresponding to a subscriber profiled may be associated with each other using hash values. For instance, an index denoting a name of the subscriber may include a first hash value pointing to another index denoting a mobile phone number of the subscriber. In some examples, the index denoting a name of the subscriber may further include a second hash value pointing to yet another index denoting a device data such as IMEI number of the device.

When it is determined that that the associated indexes do not map to a same UID, the process may continue at operation 514 to send the audit result to the client device, causing the client device to correct the error in the database. When it is determined that the associated indexes map to a same UID, the process may continue at operation 516 to perform the operation in the database, given that a storage layer auditing/back-end server auditing performed at operation 508 also succeeds.

At operation 508, to audit the subscriber data in the database, the process may include querying a plurality of UIDs associated with profiles stored in a second storage of the database. As discussed herein, a UID associated with a profile of a subscriber may be linked to all the indexes associated with the subscriber with correct index attributes. The operation 508 may also be referred to as the storage layer auditing or the back-end server auditing.

At operation 512, the process may include determining whether the UID maps to the indexes correctly. In implementations, the provisioning orchestrator may further determine whether proper index attributes and associated indexes are mapped to a correct UID. For instance, the provisioning orchestrator may determine whether an index representing a mobile phone number of a first subscriber and the mobile phone number is mapped to the correct UID associated with the first subscriber.

When it is determined that the UID maps to the indexes and/or the index attributes incorrectly, the process may continue at operation 514 to send the audit result to the client device, causing the client device to correct the error in the database. When it is determined that the UID maps to the indexes and/or the index attributes correctly, the process may continue at operation 516 to perform the operation in the database, given that the access layer auditing/front end server auditing performed at operation 506 also succeeds.

It should be understood that as the front-end server auditing and the back-end server auditing are performed in parallel, the provisioning orchestrator may consider the database remains data integrity when both the front-end server auditing and the back end server auditing reveal no error.

Particularly, at operation 514, the audit result may include one or more error codes indicating subscription data integrity issues in the database along with a list of UIDs, indexes, and/or keys as impacted by the subscription data integrity issues. The client device may automatically refresh the impacted identities (e.g., indexes, keys, IDs, UIDs, etc.) in the database so that the impacted identities (e.g., indexes, keys, IDs, UIDs, etc.) are corrected and synchronized with the identities (e.g., indexes, keys, IDs, UIDs, etc.) stored in a billing/CRM database.

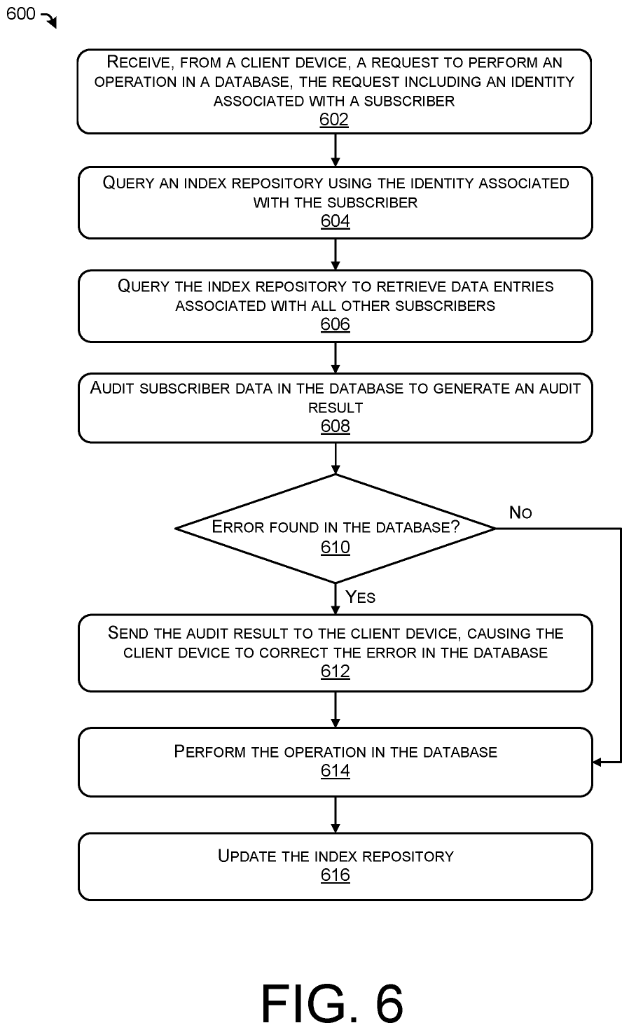

FIG. 6 illustrates another example process for implementing the techniques for subscriber data integrity assurance and auto-corrections, according to an implementation of the present disclosure. The example process 600 may be implemented on a provisioning orchestrator (e.g., the provisioning orchestrator 112 as illustrated in FIG. 1, FIG. 3, and FIG. 4) and/or a provisioning orchestrator instance in a telecommunication network. The example process 500 may correspond to the example diagram 300, where the provisioning orchestrator refers to data stored in a common index data repository to perform the auditing operation, as illustrated in FIG. 3.

At operation 602, the process may include receiving, from a client device, a request to perform an operation in a database, the request including an identity associated with a subscriber. As discussed herein, the operation may be directed to a new subscription or an existing subscription. In some examples, the request may include multiple identities associated with the subscriber. When the operation is directed to a new subscription, the request may include all indexes associated with the subscriber (i.e., new subscriber). When the operation is directed to an existing subscription, the request may include one or more of all associated indexes.

At operation 604, the process may include querying a common index data repository using the identity associated with the subscriber. As discussed herein, the common index data repository may be configured to store the mappings/relationship between the indexes and the UIDs associated with all the subscription of a telecommunication service provider. The common index data repository may reflect the up-to-date relationship between the indexes and the UIDs associated with all the subscription stored in the database and/or data storage of the telecommunication service provider and can be used as a basis for auditing the database. For an existing subscriber, the process may retrieve a data entry corresponding to the existing subscriber. The data entry may include all associated indexes/keys/identities and a unique identity (UID) associated with the existing subscriber. For a new subscriber, the process may determine that no data entry present in the common index data repository.

At operation 606, the process may include querying the common index data repository to retrieve data entries associated with all other subscribers. As discussed herein, each data entry may include all associated indexes/keys/identities and a UID corresponding to an existing subscriber.

At operation 608, the process may include auditing subscriber data in the database to generate an audit result. Similar to the example process 500, the provisioning orchestrator may audit the indexes/keys/identities stored in the access layer/front end servers and the UIDs associated with the profiles stored in the storage layer/back-end servers.

At operation 610, the process may include determining whether an error is found in the database. The provisioning orchestrator may perform one or more operations similar to operations 506, 508, 510, and 512, as described above with respect to the example process 500. As discussed herein, an error may be found when an inconsistency presents in a mapping between the indexes and the UIDs associated with a subscriber.

When the audit fails and an error is found in the database, the process may continue at operation 612 to send the audit result to the client device, causing the client device to correct the error in the database. The operation 612 is performed in a similar manner to operation 514, as described above with respect to the example process 500.

When the audit succeeds and no error is found in the database, the process may continue at operation 614 to perform the operation in the database. As discussed above with respect to the example process 500, the audit succeeds when auditing of the front-end servers and auditing of the back-end servers both pass.

At operation 616, the process may include updating the common index data repository. In circumstances where there is no error found in the database during the auditing, and the operation is to provision a subscriber profile in the database, the provisioning orchestrator may update the common index data repository to include a new mapping between the indexes and UIDs associated with the new subscriber profile. In other circumstances where the error is found and corrected, and the operation is to provision a subscriber profile in the database, the provisioning orchestrator may update the common index data repository to include not only the mapping between the indexes and UIDs associated with the new subscriber profile but also the corrected mappings for those impacted subscriber profile. In yet other circumstances where there is no error found in the database during the auditing, and the operation is to modify an existing subscriber profile in the database, the provisioning orchestrator may update the common index data repository to include the modified mappings between the indexes and UIDs associated with the existing subscriber profile. In yet other circumstances where the error is found and corrected, and the operation is to modify an existing subscriber profile in the database, the provisioning orchestrator may update the common index data repository to include not only the modified mappings between the indexes and UIDs associated with the existing subscriber profile but also the corrected mappings for those impacted subscriber profile.

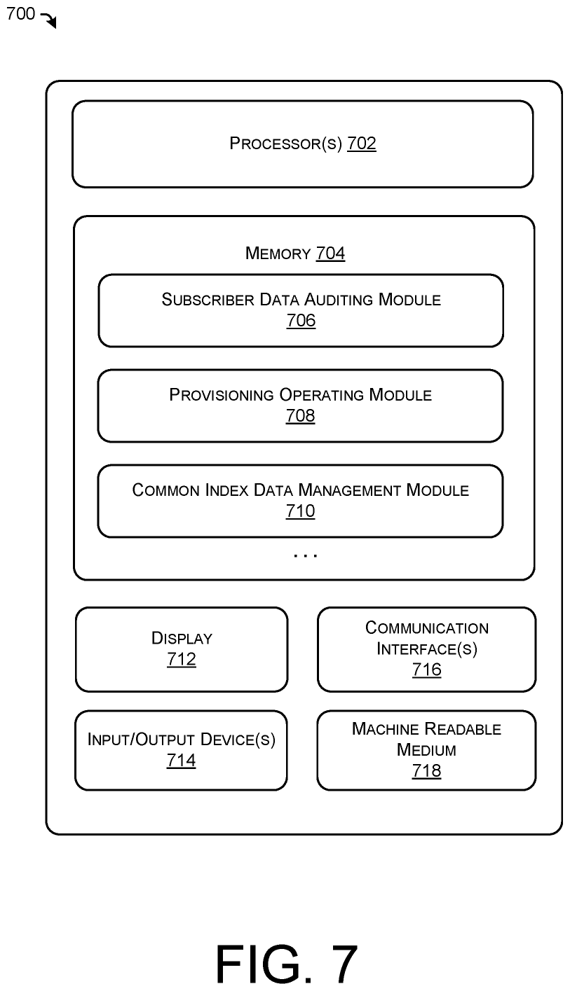

FIG. 7 illustrates an example computer device that implements techniques for subscriber data integrity assurance and auto-corrections, according to the present disclosure. The example computer device 700 may implemented by a provisioning orchestrator (e.g., the provisioning orchestrator 112 as illustrated in FIG. 1, FIG. 3, and FIG. 4) and/or a provisioning orchestrator instance in a telecommunication network.

In various examples, the processor(s) 702 can be a central processing unit (CPU), a graphics processing unit (GPU), or both CPU and GPU, or any other type of processing unit. Each of the one or more processor(s) 702 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 702 may also be responsible for executing all computer applications stored in memory 704, which can be associated with common types of volatile (RAM) and/or nonvolatile (ROM) memory.

As illustrated in FIG. 7, the computer device 700 may comprise processor(s) 702, a memory 704 storing a subscriber data auditing module 706, a provisioning operating module 708, and a common index data management module 710, a display 712, input/output device(s) 714, communication interface(s) 716, and/or a machine readable medium 718.

In various examples, the memory 704 can include system memory, which may be volatile (such as RAM), non-volatile (such as ROM, flash memory, etc.) or some combination of the two. The memory 704 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computer device 700. Any such non-transitory computer-readable media may be part of the computer device 700.

The subscriber data auditing module 706 may be configured to audit the subscriber data stored in the database and/or storage segments of a telecommunication service provider. In implementations, the subscriber data auditing module 706 may simultaneously perform auditing on different indexes and/or index attributes. The subscriber data auditing module 706 may further audit the indexes/keys in the front-end servers and UIDs associated with the profiles in the back-end servers in parallel. In some examples, the subscriber data auditing module 706 may determine whether all associated indexes are pointing to a same UID. Alternatively and/or additionally, the subscriber data auditing module 706 may determine whether the indexes and/or the proper index attributes are mapped to a correct UID. Once the auditing of the subscriber database passes, e.g., no inconsistencies being found the indexes and the UIDs, the subscriber data auditing module 706 may send a signal to the provisioning operating module 708 to perform provisioning operations. If the auditing of the subscriber database fails, e.g., an inconsistency present between the indexes/keys and the UIDs, the subscriber data auditing module 706 may send a response to the client device to correct the error. The response may generally identify the data integrity issues using pre-defined error codes and include the impacted indexes/keys/UID. Upon receiving the response, the client device may refresh only the impacted indexes/keys/UIDs to correct the errors and/or inconsistencies between the indexes and the UID.

The provisioning operating module 708 may be configured to perform provisioning operations on the database with respect to the requested subscriber after the auditing process completes and the errors get corrected. The provisioning operations may include setting up the subscriber account, setting up device to connect to the network, authorizing a subscriber to use certain types of data and/or voice services, etc. The provisioning operations may further include modifying account information, device data, and/or service data associated with the subscribers.

The common index data management module 710 may be configured to maintain a common index data repository such that the data saved in the common index data repository is up to date. In some examples, the common index data management module 710 may periodically update the data stored therein to include the up-to-date mappings between the associated indexes and the UIDs. In some other examples, the common index data management module 710 may update the data stored therein when an auditing yields a subsequent database refresh.

The communication interface(s) 716 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 716 can be compatible with multiple radio access technologies, such as 5G radio access technologies and 4G/LTE radio access technologies. Accordingly, the communication interfaces 716 can allow the computer device 700 to connect to the 5G system described herein.

Display 712 can be a liquid crystal display or any other type of display commonly used in the computer device 700. For example, display 712 may be a touch-sensitive display screen and can then also act as an input device or keypad, such as for providing a soft-key keyboard, navigation buttons, or any other type of input. Input/output device(s) 714 can include any sort of output devices known in the art, such as display 712, speakers, a vibrating mechanism, and/or a tactile feedback mechanism. Input/output device(s) 714 can also include ports for one or more peripheral devices, such as headphones, peripheral speakers, and/or a peripheral display. Input/output device(s) 714 can include any sort of input devices known in the art. For example, input/output device(s) 714 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 718 can store one or more sets of instructions, such as software or firmware, which embodies any one or more of the methodologies or functions described herein. The instructions can also reside, completely or at least partially, within the memory 704, processor(s) 702, and/or communication interface(s) 716 during execution thereof by the computer device 700. The memory 704 and the processor(s) 702 also can constitute machine readable media 718.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, are not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computer device, comprising:
a processor;
a non-transitory computer-readable memory storing computer-executable instructions that, when executed by the processor, cause the processor to perform actions including:
receiving, from a client device, a request to perform an operation in a subscription database, the operation being associated with a first subscription;
auditing subscription data stored in the subscription database to generate an auditing result; and
based on the auditing result indicating no error in the subscription database, performing the operation in the subscription database.

2. The computer device of claim 1, wherein auditing subscription data stored in the subscription database to generate an auditing result further comprises:
querying indexes stored in a first storage of the subscription database; and
determining whether associated indexes point to a same unique identity (UID); and
based on the associated indexes not pointing to the same UID, determining that there is an error in the subscription database.

3. The computer device of claim 1, wherein auditing the subscription data stored in the subscription database to generate the auditing result further comprises:
querying UIDs stored in a second storage of the subscription database; and
for each UID,
determining one or more indexes mapped to the UID,
determining that first mapping between the one or more indexes and the UID are correct,
determining that second mapping between one or more attributes corresponding to the one or more indexes and the UID are correct, and
based on at least one of the first mapping or the second mapping being incorrect, determining that there is an error in the subscription database.

4. The computer device of claim 1, wherein the computer-executable instructions, when executed by the processor, further cause the processor to:
based on the auditing result indicating an error in the subscription database, sending the auditing result to the client device, causing the client device to correct the error in the subscription database.

5. The computer device of claim 4, wherein to correct the error in the subscription database, the client device generates an instruction to refresh a portion of the subscription data associated with the error using corresponding subscription data stored in a second database,
wherein the portion of the subscription data is associated with at least an additional subscription.

6. The computer device of claim 4, wherein the auditing result includes at least one of:
a pre-defined error code indicating a type of the error,
one or more impacted UIDs, or
one or more impacted indexes.

7. A computer device, comprising:
a processor;
a non-transitory computer-readable memory storing computer-executable instructions that, when executed by the processor, cause the processor to perform actions including:
receiving, from a client device, a request to perform an operation with respect to a first subscription in a subscription database;
obtaining, from an index repository, a plurality of UIDs and associated indexes for a plurality of subscriptions;
auditing, based on the plurality of UIDs and associated indexes, the subscription database to generate an auditing result; and
based on the auditing result indicating no error in the subscription database, performing the operation with respect to the first subscription in the subscription database.

8. The computer device of claim 7, wherein the request includes a first UID and associated first indexes, and the request to perform the operation includes activating the first subscription, wherein performing the operation with respect to the first subscription in the subscription database further includes:
writing the first UID and the associated first indexes in an access layer of the subscription database; and
writing profile data of the first subscription in a storage layer of the subscription database.

9. The computer device of claim 8, wherein the computer-executable instructions, when executed by the processor, cause the processor to perform actions including:
updating the index repository to include a new mapping between the first UID and the associated first indexes for the first subscription.

10. The computer device of claim 7, wherein the computer-executable instructions, when executed by the processor, cause the processor to perform actions including:
based on the auditing result indicating an error in the subscription database, sending the auditing result to the client device, causing the client device to correct the error in the subscription database.

11. The computer device of claim 10, wherein to correct the error in the subscription database, the client device generates an instruction to refresh a portion of subscription data associated with the error in the subscription database using corresponding subscription data stored in a second database.

12. The computer device of claim 7, wherein the request includes a first UID and associated first indexes, and the request to perform the operation includes modifying the first subscription, wherein the computer-executable instructions, when executed by the processor, cause the processor to perform actions including:
auditing, based on the first UID and the associated first indexes, the subscription database;
determining, based on the auditing, whether mappings between the first UID and the associated first indexes are correct; and
based on the mappings between the first UID and the associated first indexes being correct, performing the operation to modify the first subscription in the subscription database.

13. The computer device of claim 12, wherein the computer-executable instructions, when executed by the processor, cause the processor to perform actions including:
determining at least one mapping between the first UID and the associated first indexes is incorrect;
sending a response to the client device, causing the client device to refresh a portion of subscription data associated with the at least one mapping in the subscription database using corresponding subscription data stored in a second database; and
generating a corrected mapping between the first UID and the associated first indexes for the first subscription.

14. The computer device of claim 13, wherein the computer-executable instructions, when executed by the processor, cause the processor to perform actions including:
updating the index repository to include the corrected mapping between the first UID and the associated first indexes for the first subscription.

15. A computer-implemented method, comprising:
receiving, from a client device, a request to perform an operation with respect to a first subscription in a subscription database;
obtaining, from an index repository, a plurality of UIDs and associated indexes for a plurality of subscriptions;
auditing, based on the plurality of UIDs and associated indexes, a subscription database to generate an auditing result; and
based on the auditing result indicating no error in the subscription database, performing the operation with respect to the first subscription in the subscription database.

16. The computer-implemented method of claim 15, wherein the request includes a first UID and associated first indexes, and the request to perform the operation includes activating the first subscription, wherein performing the operation with respect to the first subscription in the subscription database further includes:
writing the first UID and the associated first indexes in an access layer of the subscription database; and
writing profile data of the first subscription in a storage layer of the subscription database.

17. The computer-implemented method of claim 16, further comprising:
updating the index repository to include a new mapping between the first UID and the associated first indexes for the first subscription.

18. The computer-implemented method of claim 15, wherein the request includes a first UID and associated first indexes, and the request to perform the operation includes modifying the first subscription, and the computer-implemented method further comprises:
auditing, based on the first UID and the associated first indexes, the subscription database;
determining, based on the auditing, whether mappings between the first UID and the associated first indexes are correct; and
based on the mappings between the first UID and the associated first indexes being correct, performing the operation to modify the first subscription in the subscription database.

19. The computer-implemented method of claim 18, further comprising:
determining at least one mapping between the first UID and the associated first indexes is incorrect;
sending a response to the client device, causing the client device to refresh a portion of subscription data associated with the at least one mapping in the subscription database using corresponding subscription data stored in a second database; and
generating a corrected mapping between the first UID and the associated first indexes for the first subscription.

20. The computer-implemented method of claim 19, further comprising:
updating the index repository to include the corrected mapping between the first UID and the associated first indexes.
